(19) United States
(12) Patent Application Publication
(10) Pub. No.: US 2013/0144663 A1
(43) Pub. Date: Jun. 6, 2013

(54) Online and Offline Authentication for Instant Physical or Virtual Access and Purchases

(71) Applicant: Spenzi, Inc., San Jose, CA (US)

(72) Inventors: Bahman Qawami, San Jose, CA (US); Branimir Z. Talaich, Saratoga, CA (US); Matthew J. Farrell, San Jose, CA (US)

(73) Assignee: SPENZI, INC., San Jose, CA (US)

(21) Appl. No.: 13/689,687

(22) Filed: Nov. 29, 2012

Related U.S. Application Data
(60) Provisional application No. 61/565,988, filed on Dec. 2, 2011.
(60) Provisional application No. 61/565,979, filed on Dec. 1, 2011.
(60) Provisional application No. 61/586,765, filed on Jan. 14, 2012.
(60) Provisional application No. 61/594,699, filed on Feb. 3, 2012.

(51) Int. Cl. G06Q 10/02

(52) U.S. Cl. CPC G06Q 10/02
USPC 705/5

(57) ABSTRACT

A customer enters his mobile phone number to logon to a third-party website without a username or password. A Short Message Service (SMS) Applications-Programming Interface (API) sends the phone number to a SMS control system that authorizes the logon by sending a SMS text message or secure hypertext transfer protocol (HTTPS) request to the customer's mobile phone or mobile device requiring customer to respond by SMS or HTTPS. When the customer replies to the SMS message with an approval code such as a Personal-Identification-Number (PIN), the SMS control system approves the logon to the third-party website. An admittance gate at an event such as a concert or movie may also get the customer's phone number and use the API to activate the SMS control system to exchange SMS text messages to authorize admittance. A pre-paid ticket in an admittance queue is redeemed in the customer's account.

### RELATED APPLICATIONS

This application claims the benefit of the U.S. provisional applications for “Enabling user transaction to request, order, post transaction using mobile phone and/or online”, U.S. Provisional Ser. No. 61/565,988, filed Dec. 2, 2011, and “Shopping with Spenzi”, U.S. Provisional Ser. No. 61/586,765, filed Jan. 14, 2012, and “Enabling users to access process order post and login via a transactional based system”, U.S. Provisional Ser. No. 61/565,979, filed Dec. 1, 2011, and “Spenzi SaaS Payment Gateway Host For Mobile Payment”, U.S. Provisional Ser. No. 61/594,699, filed Feb. 3, 2012. This application is also related to the co-pending application for “Enabling a Merchant's Storefront POS (Point of Sale) System to Accept a Payment Transaction Verified by SMS Messaging with Buyer's Mobile Phone”, U.S. Ser. No. 13/466,435, filed May 8, 2012 and “Gifting and Sharing Using SMS Messages for Shared Coupon/Gift-Card Auto-Redemption and Multi-Source Payment from Buyer's Mobile Phone”, U.S. Ser. No. 13/677,267, filed Nov. 14, 2012.

### FIELD OF THE INVENTION

This invention relates to mobile verification of online login or of physical admittance, and more particularly to using standard mobile phones to verify admittance and related actions.

### BACKGROUND OF THE INVENTION

An abundance of virtual resources are available to Internet users. Many of these resources are accessible through web sites that require a user to register for an account. Users may establish accounts at dozens or hundreds of web site, each requiring a username (user identifier or UserID) and a password.

A single user may have to memorize dozens of usernames and passwords. Some users may instead use the same username and password at multiple web sites, but some web sites may periodically prompt the user to change his password, or some sites may require longer, more secure passwords. Security may be compromised if any one of the web sites using the common username and password is hacked.

Some web services and utilities such as password safes allow a user to store a multitude of usernames and passwords. Certain web browsers may offer to store usernames and passwords when browsing to a logon page. While useful for stationary uses such as on a desktop personal computer (PC), mobile users may not have access to their passwords when not at a home or office.

Events such as movies, sports, theater, and fairs usually require a paper ticket for entrance. Usernames and passwords may be required to purchase these tickets online, but in the real offline world, a paper ticket or a confirmation number is usually required for admittance to an event. More recently, a bar code or QR code displayed on a mobile phone may be readable at an admittance gate (such as at an airport) without requiring that a paper ticket be printed out and presented for admittance.

FIGS. 1A-C show various prior-art logon options. In FIG. 1A, standard logon page 200 is displayed to a user. The user enters his username (UserID) into box 202, and his password into box 204. When the user clicks logon button 206, the web site verifies his username and password before allowing admittance to the web site and its resources.

FIG. 1B shows a third-party website that allows logon using the customer's logon credentials for another web site. Water district web site 210 is for a local utility that has resources such as for displaying and paying customer bills. A customer may create a username and password for the water district and enter them into boxes 212, 214, and gain access to the web site by pressing logon button 216. However, the customer may not desire to remember another username and password just for his water bill.

Instead, the customer may use his logon credential for a more frequently accessed web site, such as google (gmail) or facebook. Thus the customer may gain access to the water district web site without remembering another username and password. The customer leaves boxes 212, 214 blank, and instead clicks on google button 218 to logon using his google credentials, or clicks on f-connect button 208 to logon with his facebook credentials.

In FIG. 1C, the customer clicked on f-connect button 208 (FIG. 1B) and facebook account logon screen 220 is displayed. The customer enters his facebook username into box 222, and his facebook password into box 224. When the customer clicks logon button 226, a web server controlled by facebook verifies the customer's username and password, and informs the water district web server that the user has been verified. Other information such as the user's real name, address, or phone number may be sent from the facebook server to the water district server to allow the customer's records to be located within the water district's database.

Box 222 may also allow the user to enter some other identifier other than his facebook username. For example, the customer's phone number or email address could be entered and matched to the customer's phone number or email address stored with facebook. Thus the customer is able to access the water district's web site and his water bill without remembering another username and password.

While web accesses have traditionally be made from a stationary device such as a desktop personal computer (PC), more recently mobile phones are being used for web browsing and even for mobile payments.

Mobile payments typically use mobile phones and credit or debit cards to allow users to pay for purchases. Many different mobile payment schemes have been proposed, and several are being tested. Success of these schemes has been limited for various reasons.

Some mobile payment systems may support one brand of smartphones but not other brands. Since the smartphone market is currently split, mobile payment systems that support only Apple iOS, Android, Windows Mobile, or Blackberry OS phones eliminate half or more of the potential cell-phone users.

While smartphones have received a great deal of attention, many users still have older cell phones that do not run Apple iOS, Android, Windows Mobile, or Blackberry OS software. The high cost of smartphones limits their acceptance in cost-sensitive foreign markets and among cost-sensitive customers.

The fragmented mobile phone market limits the success of mobile payment systems that function with only a particular kind of smartphone, or that do not work with older legacy cell phones. The inventors believe that the widespread acceptance of a mobile payment system depends on it being able to operate with all kinds of mobile phones, including smart phones of all types, and legacy cell phones.

A related application for “Enabling a Merchant's Storefront POS (Point of Sale) System to Accept a Payment Transaction Verified by SMS Messaging with Buyer's Mobile Phone”, U.S. Ser. No. 13/466,435, filed May 8, 2012, describes how Short Message Service (SMS) text messages can be used with a modified merchant Point-Of-Sale (POS) system to verify and approve a payment using a traditional payment method, such as a credit card. The credit card information may be stored remotely, allowing the user to make payment to the merchant without showing the credit card to the merchant. Approval by the user is obtained using SMS text messages. A novel SMS payment system communicates with the user/customer through SMS text messages to verify the payment to the merchant.

While such a SMS payment system is useful, Applicant's desire to also use SMS text messages to verify online admittance to web sites, and offline admittance to paid events.

What is desired is a SMS control system that uses SMS text messages to verify logon credentials. A SMS verification system that uses SMS text messages to a customer' mobile phone is desirable that can verify logon to a web site and can also verify admission to an event. A SMS verification system that stores pre-purchases event tickets in an admittance queue and redeems a stored event ticket when a customer is admitted to an event is also desirable.

### BRIEF DESCRIPTION OF THE DRAWINGS

FIGS. 1A-C show various prior-art logon options.

FIGS. 2A-B shows a third-party website that allows logon verified by text messages with the customer's mobile phone.

FIG. 3 is a transaction diagram showing steps in logon on to a third-party website using SMS verification.

FIG. 4 is a block diagram of an SMS mobile control system.

FIG. 5 is a diagram of a SMS control system host.

FIG. 6 shows a customer configuring an admittance queue.

FIG. 7 is a transaction diagram showing steps in admittance to a third-party event using SMS verification.

FIG. 8 highlights SMS text messages for deal sharing via forwarding using the SMS control system.

FIG. 9 highlights text messages for an SMS-Instant-Buy operation.

FIG. 10 is a transaction diagram showing instantly buying an item using SMS verification.

FIG. 11 highlights a SMS text messages that advertises an instant buy using the SMS control system.

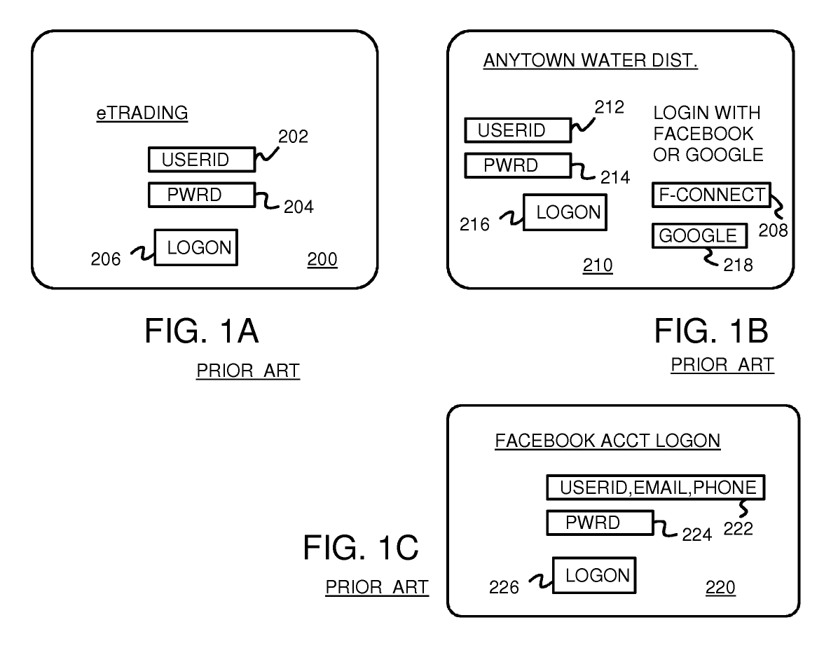

### DETAILED DESCRIPTION

The present invention relates to an improvement in Short Message Service (SMS) admittance verification and related operations. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

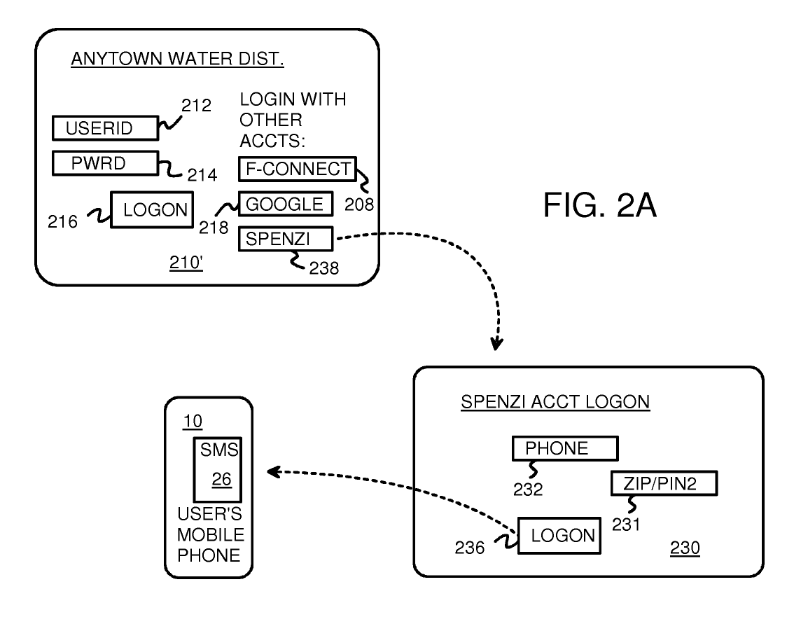

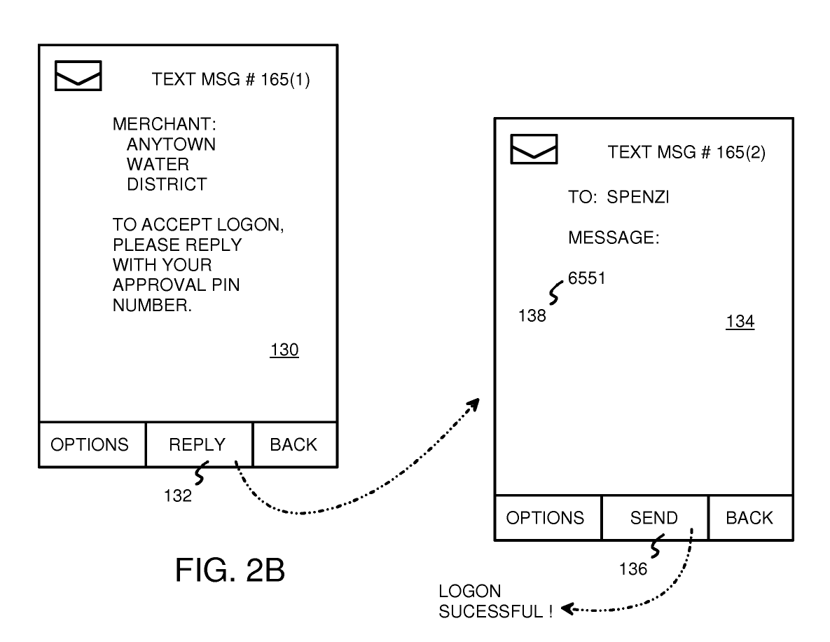

FIG. 2A shows a third-party website that allows logon verified by text messages with the customer's mobile phone.

Water district web site 210′ is for a local utility company that has resources such as for displaying and paying customer bills. A customer may create a username and password for the water district web site and enter them into boxes 212, 214, and gain access by pressing logon button 216. However, the customer may not desire to remember another username and password just for his water bill.

Instead, the customer may use his logon credentials for more frequently accessed web sites, such as google (gmail) or facebook. Thus the customer may gain access to the water district web site without remembering another username and password. The customer leaves boxes 212, 214 blank, and instead clicks on google button 218 to logon using his google credentials, or clicks on f-connect button 208 to logon with his facebook credentials.

The water district has also added a “Spenzi” button (mobile logon button 238) to allow the customer to logon using his mobile phone. Mobile logon button 238 is located near google button 218 and f-connect button 208 and can be provided to web site operators as a bundle of buttons (HTML, Javascript, or other code) that allow for alternative logons.

When the customer clicks on mobile logon button 238, an Application-Programming Interface (API) is activated that performs an alternative logon routine. Mobile logon screen 230 is generated and displayed to the customer, such as in a pop-up window above the display of water district web site 210′. The customer enters his mobile phone number in phone box 232, and optionally enters his zip code or PIN2, an alternative Personal-Identification-Number (PIN) into zip box 231. When the customer clicks on logon button 236, the API or another routine sends the phone number and the optional zip/PIN2 to a server at the mobile payment service called “Spenzi” that the customer has previously registered with.

The mobile payment service looks up the customer by the mobile phone number in its customer database, and matches the zip code or PIN2 if that was also required. The mobile payment service then sends a SMS text message to mobile device 10. SMS application 26 on mobile device 10 displays this SMS text message to the customer.

FIG. 2B shows SMS text message 130 displayed to the customer on mobile device 10. SMS text message 130 indicates the merchant is the Water District, which maintains water district web site 210′ that the customer is logging on to. SMS text message 130 asks the customer to reply with his approval PIN to accept the logon.

The customer then presses reply button 132 on mobile device 10 and types in approval PIN 138. The customer's approval PIN 138 is entered as “6551” by the customer typing in these 4 digits using a key pad on mobile device 10. The key pad may be an alphanumeric keyboard that is displayed on the display screen of mobile device 10, or may be physical telephone number keys on mobile device 10. Then the customer presses send button 136 to send reply SMS text message 134 back to the SMS payment system.

The SMS payment system then matches approval PIN 138 to a stored approval PIN in its customer database to verify logon. Once matched, the SMS payment system sends a message to the servers running water district web site 210′ to indicate that the customer logon is verified. Water district web site 210′ may then lookup the customer's water records, such as by using the customer's mobile phone number, or by using an account number or linking number for the customer that the SMS payment web site send to the servers for water district web site 210′. The SMS payment system may send the user's real name, address, or phone number to the servers for water district web site 210′.

Note that approval PIN 138 is a different PIN than ZIP/PIN2 entered into box 231 (FIG. 2A). Some embodiments may not display box 231 to the customer and may not require the zip code or second PIN. Other embodiments may have a higher level of security and therefore display box 231 and match the zip code or secondary PIN.

Thus the customer is able to access the water district's web site and his water bill without remembering another username and password. Verification of the logon is provided by exchanging SMS text messages with the customer's mobile device 10. Physical possession of mobile device 10 is required for logon, which enhances logon security.

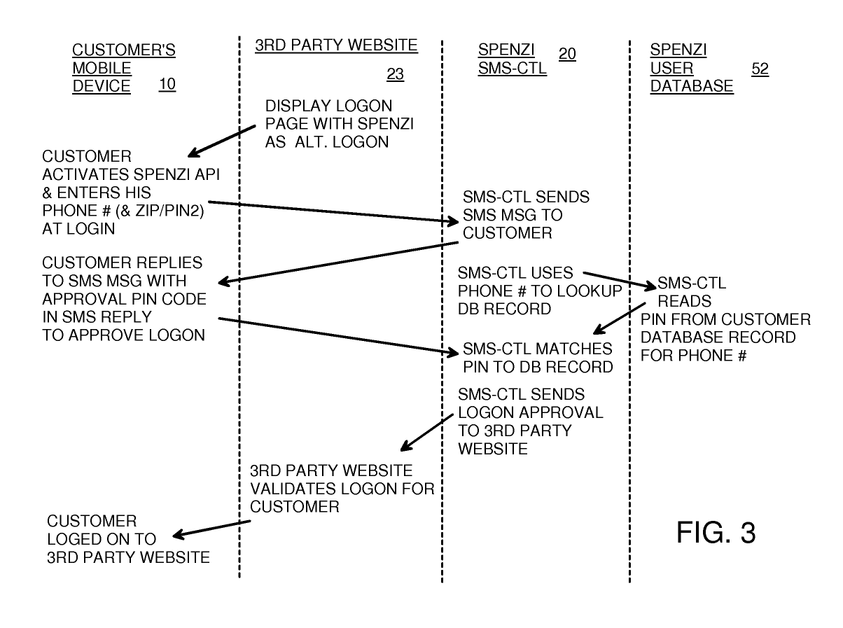

FIG. 3 is a transaction diagram showing steps in logon on to a third-party website using SMS verification. The customer carries mobile device 10, such as a smartphone of any kind, or a legacy cell phone that supports SMS text messaging. Third-party website 23 displays a logon page to the customer, such as shown in FIG. 2A. This logon page supports alternate logons such as for the Spenzi mobile payment service.

The customer presses a Spenzi button, selects Spenzi from a drop-down or menu list of alterante logon providers, or otherwise activates a Spenzi API. This API causes a Spenzi logon screen to be displayed, prompting the customer to enter his mobile phone number. Some more secure embodiments may also prompt the user for his zip code or for a secondary code, PIN2.

The customer's mobile phone number is then sent to SMS control system 20. SMS control system 20 receives the logon request and sends a SMS text message to mobile device 10 to confirm the logon. The customer replies to the SMS text message with his approval Personal-Identification-Number (PIN) code and the reply SMS text message is routed from mobile device 10 back to SMS control system 20.

SMS control system 20 uses the customer's mobile phone number to lookup the customer's record in customer SMS user database 52. The approval PIN received from mobile device 10 is compared to a stored PIN in the customer's record in SMS user database 52. This comparison may be a direct comparision of values, or the two PIN values may be inputs into a more complex key comparision engine or other mechanism to keep the approval PIN secure or encrypted.

Once SMS control system 20 has verified that the approval PIN matches the stored PIN from SMS user database 52, SMS control system 20 sends a logon approval response to third-party website 23. Third-party website 23 then validates the customer's logon, and the customer is logged on to third-party website 23.

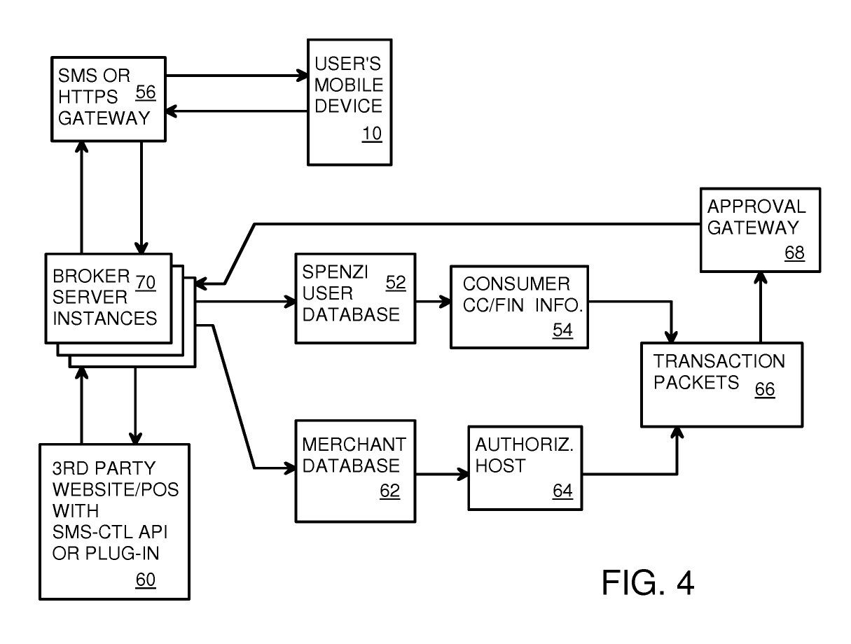

FIG. 4 is a block diagram of an SMS mobile control system. A customer carrying mobile device 10, such as a mobile phone, has previously registered to use SMS control system 20. The customer's data is stored in Spenzi's database, SMS user database 52, which includes an approval PIN that the customer selects. Other information may be included, such as the customer's zip code, or another PIN, such as the PIN2, that the user pre-selects. The customer may also enter payment information, such as for one or more credit cards, debit cards, gift cards, etc., which are stored in customer financial information database 54. The customer can enter payment, PIN, and other information at a web site for the SMS control system, or using a mobile app that links to that website.

SMS-control API 60 is installed at third-party website 23, at other third-party websites, and perhaps at merchant Point-Of-Sale (POS) terminals or other devices. The software executing on third-party web sites may be modified using instructions or commands that use an applications-programming interface (API) that connects to broker server instances 70 at SMS control system 20, or by installing a plugin app, API, or other methods. In one embodiment, SMS-control API 60 is activated when a user clicks on a displayed button with a trade name of SMS control system 20.

Broker server instances 70 are created on the servers at SMS control system 20 to process various requests including logon requests from SMS-control API 60 activated at third-party websites. Broker server instances 70 parse the incoming requests. Logon requests are parsed for the customer's mobile phone number, which is looked up in SMS user database 52. Broker server instances 70 also extract an identifier of third-party website 23 or otherwise track the source of the logon request.

Broker server instances 70 then create SMS text message 130 (FIG. 2B) that is sent to mobile device 10 after being formatted as an SMS message by SMS gateway 56. The reply SMS text message or HTTPS connection messages are received from mobile device 10 by SMS gateway 56 and passed on to the requesting one of broker server instances 70. The reply text message contains the approval PIN that the customer entered on mobile device 10. Broker server instances 70 match that approval PIN from mobile device 10 with a stored approval PIN in SMS user database 52 that the customer previously selected and stored.

For logon requests, broker server instances 70 send a successful logon verification message back to SMS-control API 60, or directly back to third-party website 23 once the SMS reply message is received and the approval PIN has been matched.

For other financial transactions, such as purchases by the customer, broker server instances 70 create transaction packets 66 once the customer's approval PIN is matched. The customer's payment information from customer financial information database 54 is combined with the merchant's information from merchant database 62 to form transaction packets 66 for purchases, or for SMS control system 20 acting as the merchant for gifts. The merchant's information may include pre-configured settings for a payment gateway that are provided by authorization host 64, which may be a third-party payment processor, bank, or other financial or merchant institution.

Broker server instances 70 may use the merchant's identifier from the request from merchant POS devices 60 to lookup merchant information in merchant database 62, and this merchant information is then sent to authorization host 64 and the reply data from authorization host 64 then merged into transaction packets 66 that are sent on to payment gateway 68.

Transaction packets 66, which have detailed financial information such as cardholder data and authentication data, stored in database 54, are sent to payment gateway 68. Payment gateway 68 processes the payment requests and responds with authorization codes and indicates that the transaction is completed, or with an error code.

Broker server instances 70 receive the authorization code from payment gateway 68 for the request, and send an approval message to merchant POS devices running SMS-control API 60 and to mobile device 10 through SMS gateway 56.

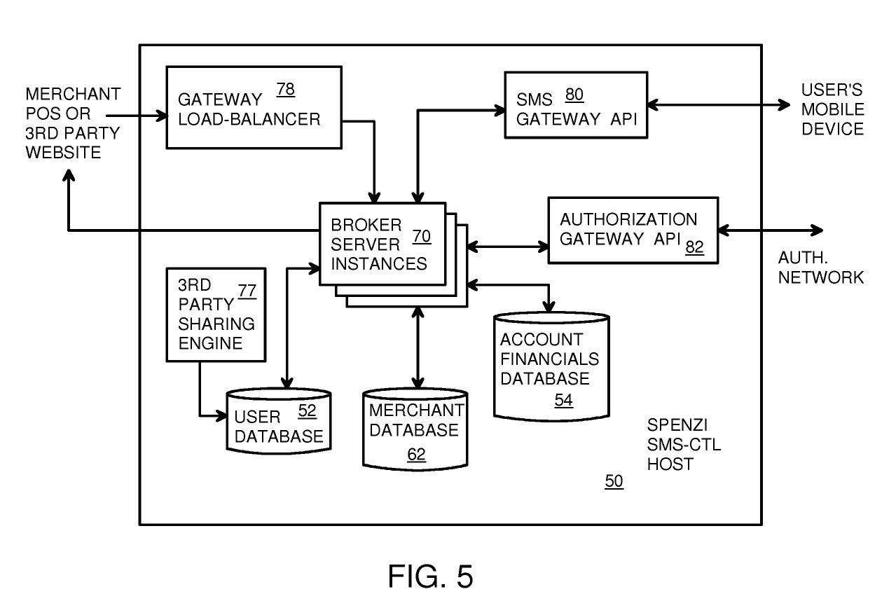

FIG. 5 is a diagram of a SMS control system host. SMS control host 50 has SMS user database 52 that is populated with user records when a customer registers at a web site and enters his mobile phone number, mailing addresses, zip code (or POS PIN), and approval PIN. Merchant database 62 is populated by merchant records for merchants or other third-party websites that have installed SMS-control API 60 or other code to logon through SMS control host 50. Customer financial information database 54 contains the detailed financial information obtained when customers register, such as the credit card numbers, expiration dates, billing addresses, and verification codes. Additional levels of security such as encryption may be used to store data in customer financial information database 54 than with SMS user database 52.

Incoming requests from merchant POS terminals, SMS-control API 60, or third-party websites 23 and other merchant devices are load-balanced by gateway load-balancer 78 and assigned to instances in broker server instances 70 for processing. Text messages to customer mobile phones and other mobile devices that are generated by broker server instances 70 are formatted as SMS messages using SMS gateway API 80. HTTPS connections may be used in place of SMS and issued and then received by broker server instances 70. SMS reply messages and gift request messages from customer mobile devices are returned using SMS gateway API 80 to broker server instances 70.

Payment request packets to the authorization networks or gateways are created by instructions executed by broker server instances 70 that use authorization gateway API 82. Different merchants may require that broker server instances 70 send requests to different authorization networks or payment processors who use different API's.

Third-party sharing engine 77 allows third-party websites with SMS-control API 60 to access customer accounts in SMS user database 52 when a user logs on using SMS-control API 60 at third-party website 23 through SMS control system 20. For example, third-party sharing engine 77 may store account numbers or other linking information for use by the third-party website so that the customer's account at the third-party website may be located.

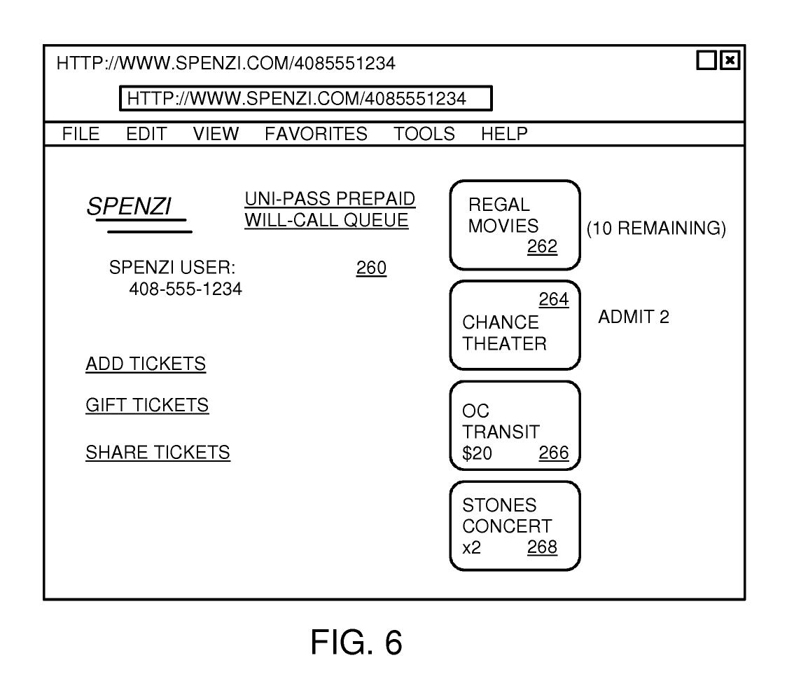

FIG. 6 shows a customer configuring an admittance queue. The customer may press a menu or other button (not shown) on a home account screen for the web site of SMS control system 20 to display admittance queue screen 260. The customer may purchase tickets to various events by clicking the “Add Tickets” link and selecting events using various other display screens.

The customer has previously purchased 10 movie tickets for any movie at any time at Regal Theaters. This is shown in the displayed admittance queue as movie tickets 262. The customer also has 2 tickets to a specific play at Chance Theater, shown by theater tickets 264. OC transit pass 266 shows that the customer has a $20 credit on his transit card. Stones tickets 268 are virtual tickets for a specific date to a rock concert. Tickets 264, 268 may be assigned seats or seats may be assigned later, such as at the door.

Additional tickets, passes, or other admittance rights may be configured by clicking the “Add Tickets” link to buy tickets. Membership cards that offer unlimited admittance for a period of time, such as for a one-year gym or fitness club membership, could also be configured. Additional screens or pop-ups may be displayed to the customer to enter other information, payments, or to make selections.

The customer may also give some of his tickets to others by clicking “Gift Tickets” and following prompts. The tickets will be removed from admittance queue screen 260 for the giving customer and displayed on admittance queue screen 260 for the receiving customer. Tickets may also be shared among several customers, being displayed on multiple admittance queue screens 260. However, once any of the customers redeems a ticket, it will disappear from all admittance queue screens 260.

The admittance queue could also contain virtual tickets for admittance to third-party websites. For example, a virtual ticket could be placed in the admittance queue for the water district web site. When the customer logs on to water district web site 210′ using SMS Control System 20, the virtual ticket is located and the customer's water district account number returned with the logon approval once the SMS reply is received from the customer's mobile device. Thus both logon to third-party websites and physical admittance could be handled by the same mechanism.

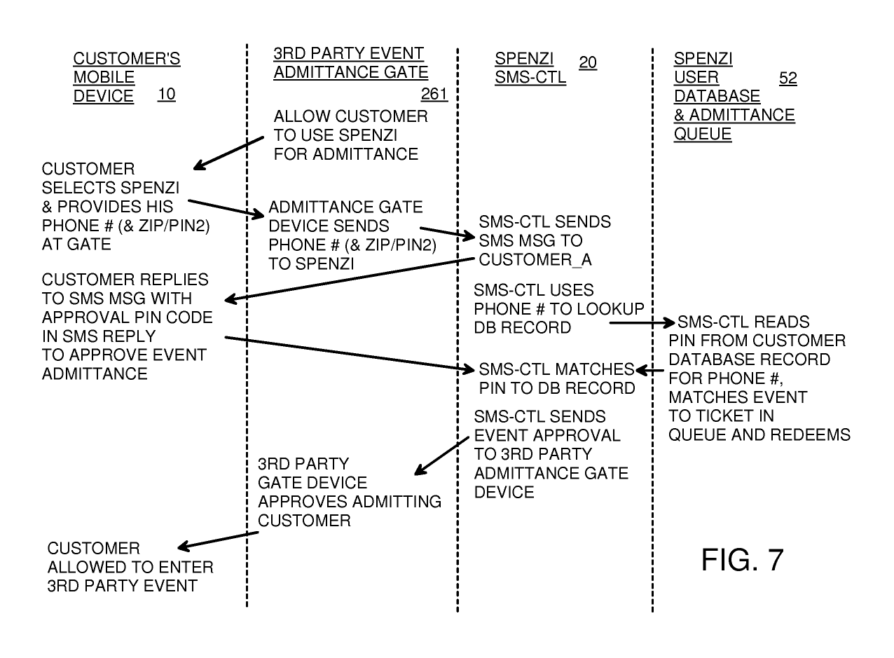

FIG. 7 is a transaction diagram showing steps in admittance to a third-party event using SMS verification. The customer carries mobile device 10, such as a smartphone of any kind, or a legacy cell phone that supports SMS text messaging. Third-party event 261 allows the customer to use his mobile device 10 for admittance using SMS control system 20 for verification.

At the admittance gate of the third-party event, such as at a ticket booth, turnstile with a display screen, kiosk, or a hand-held ticket scanner, the customer indicates that he has previously purchased a ticket through Spenzi, the operator of SMS control system 20. The customer may make this indication by using a display screen at the admittance gate, by tapping his mobile device 10 that is equipped with a Near-Field-Communication (NFC) interface, or by telling an operator of the admittance gate. The customer also is essentially providing his mobile phone number at the admittance gate. The customer may also provide his zip code or alternate PIN2 in some embodiments.

The admittance gate may have a computer that executes SMS-control API 60 or some other code that transmits the customer's phone number to SMS control system 20.

SMS control system 20 receivers the admittance request and may send a SMS text message to mobile device 10 to confirm the admittance. The customer replies to the SMS text message with his approval Personal-Identification-Number (PIN) code and the reply SMS text message is routed from mobile device 10 back to SMS control system 20.

SMS control system 20 uses the customer's mobile phone number to lookup the customer's record in customer SMS user database 52. The approval PIN received from mobile device 10 is compared to a stored PIN in the customer's record in SMS user database 52.

SMS control system 20 also uses an identifier from the admittance gate to determine the event or venue. This event or venue is matched to one of the tickets in admittance queue screen 260 (FIG. 6). For example, the admittance gate may be located at Regal Theaters, and thus one of movie tickets 262 is redeemed. The matched ticket is marked as redeemed and removed from admittance queue screen 260.

Once SMS control system 20 has verified that the approval PIN matches the stored PIN from SMS user database 52, and has found a matching ticket to redeem, SMS control system 20 sends a admittance approval to the admittance gate device at third-party event 261. Third-party event 261 then validates the customer's admittance, and the customer is allowed to enter the event.

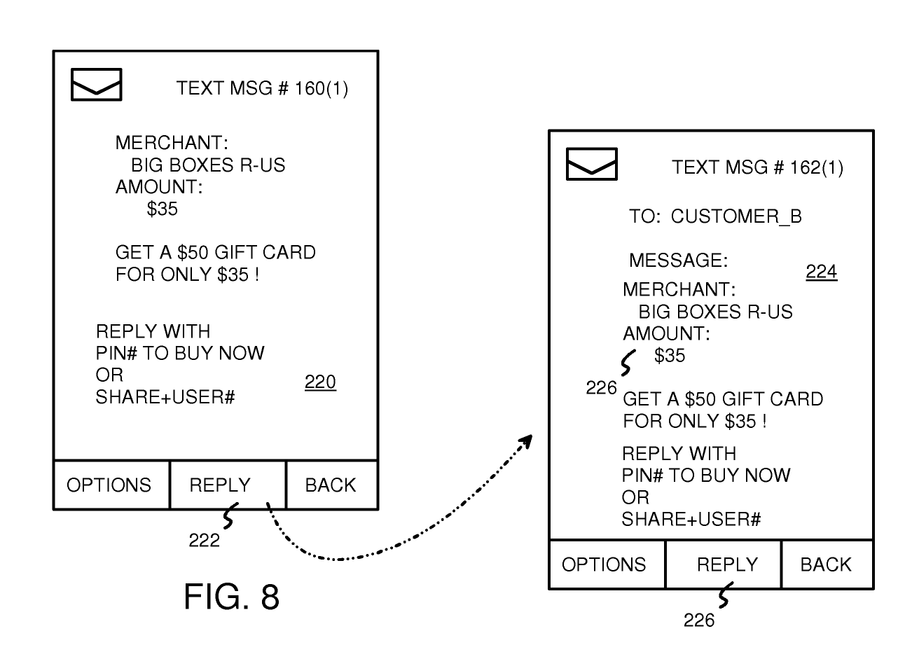

FIG. 8 highlights SMS text messages for deal sharing via forwarding using the SMS control system. A merchant sends advertisement SMS text message 220 to customer A's mobile phone. The deal is for a $50 gift card for only $35. This deal is linked to customer A's account, so that customer A can auto-redeem the deal in the future.

Customer A could immediately accept the deal and buy the gift card in advertisement SMS text message 220 by touching reply button 222 and replying with his PIN code. The deal would be redeemed and the cost charged to customer A's primary credit card, or to back-up credit or debit cards, according to Customer A's payment instructions that were previously configured. This instant buying by SMS text messages may also allow the customer to specify a quantity of gift cards or other items, such as by exchanging additional text messages and replies.

Customer A could also forward the deal to customer B. Customer A hits reply button 222 on his mobile device, then types in the key word “SHARE” followed by the mobile phone number of customer B. After customer A sends the reply to the SMS control system, the SMS control system creates another advertisement SMS text message 224 that is sent to customer B's mobile device. Customer B could also immediately buy the advertised item by touching reply button 226 and entering his PIN code. If customer B is not a user of the SMS control system, hitting reply button 226 could have the SMS control system generating additional SMS text messages to customer B's mobile phone, allowing customer B to sent up an account with the SMS control system.

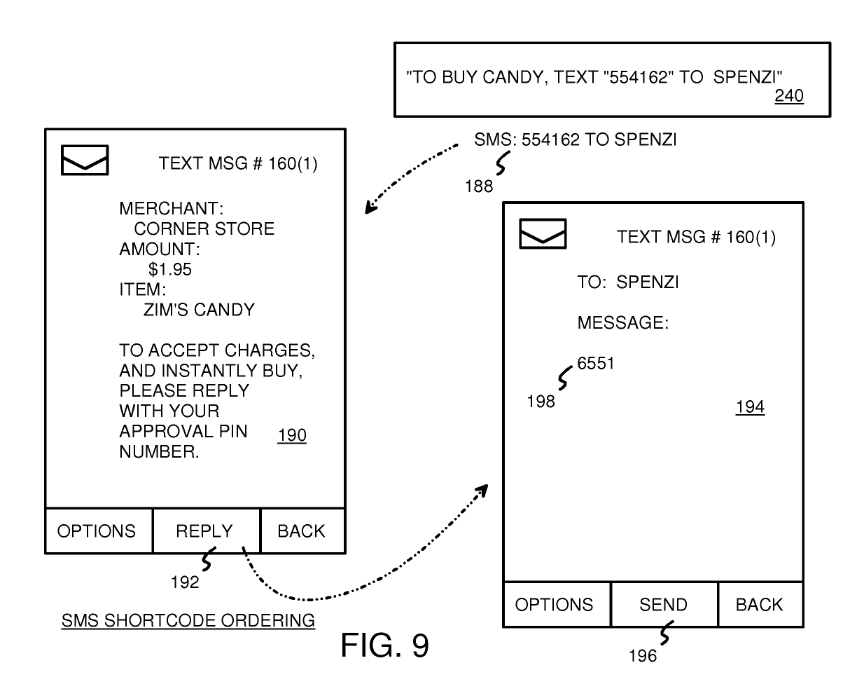

FIG. 9 highlights text messages for an SMS-Instant-Buy operation. A merchant displays sign 240 in a store that a customer sees. Sign 240 tells the customer to text a certain code to Spenzi, the operator of SMS control system 20. The sign may also include other information, such as the price of the item.

The customer wants to buy the item. The customer opens the SMS message application on his mobile device and creates a new message with the code from sign 240 as the content. The new message is then sent to Spenzi, as sign 240 instructs.

SMS control system 20 receives the new message and looks up the mobile phone number in SMS user database 52 to find the customer's account. The account has a default credit card set for payments, as well as an optional configuration for a default delivery method and address. SMS control system 20 also looks up the code from sign 240 that was in the new message, and finds the matching item and merchant. The item's description and price are displayed in text message 190 that is sent to the customer's mobile device. Text message 190 also asks the customer to reply with his approval PIN to approve the purchase.

The customer then presses reply button 192 on mobile device 10 and types in approval PIN 198. The customer's approval PIN 198 is entered as “6551” by the customer typing in these 4 digits using a key pad on mobile device 10. Then the customer presses send button 196 to send reply SMS text message 194 back to the SMS payment system.

The SMS payment system then matches approval PIN 198 to a stored approval PIN in its customer database to verify the purchase. Once matched, the SMS payment system sends a message to the merchant to indicate that the customer has made payment. The merchant then gives, delivers, or ships the customer the item, or allows the customer to leave with the item. A default delivery method and address or pickup location could be used.

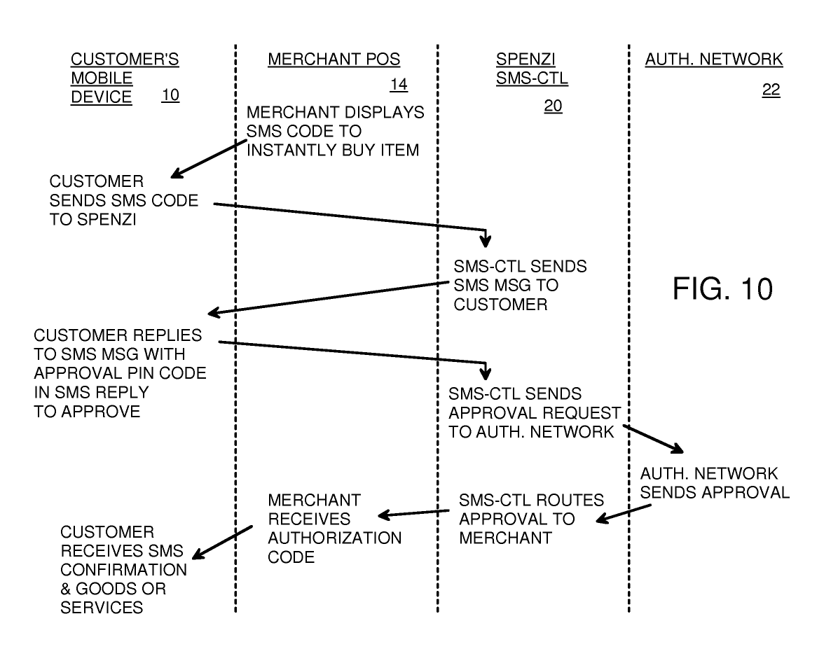

FIG. 10 is a transaction diagram showing instantly buying an item using SMS verification. The customer carries mobile device 10, such as a smartphone of any kind, or a legacy cell phone that supports SMS text messaging. The customer sees a sign displayed by the merchant that has an SMS code to instantly buy an item. The merchant's signal also instructs the customer to send the SMS code to Spenzi, the operator of SMS control system 20.

The customer creates a SMS text message on mobile device 10. The new text message has the SMS code from the merchant's sign, and is sent to Spenzi.

SMS payment system 20 receives the new text message from the customer and sends a SMS text message over the cellular network to the customer at the customer's mobile phone number. The customer receives the SMS text message, reads it, and replies to this SMS text message with an approval PIN code that the customer had previously selected. The reply SMS text message is sent over the cellular network from the customer's mobile device to SMS payment system 20. SMS payment system 20 verifies that the approval PIN is correct, and sends an authorization request to bank authorization network 22 with a request to pay the merchant.

The authorization request from SMS payment system 20 is processed by bank authorization network 22, causing a charge to be made to the credit card or other payment source previously configured by the customer, with payment made to the vendor selling the item. The vendor and item are identified from the SMS code in the customer's original text message, which are also on the merchant's sign in the store.

An approval message generated by bank authorization network 22 is sent back to SMS payment system 20, which routes the approval back to the merchant's POS terminal along with an authorization code.

SMS payment system 20 also sends another SMS text message to mobile device 10 to tell the customer that the purchase has been approved. The store clerk gives the merchandise to the customer once the approval is received by the POS terminal from SMS payment system 20.

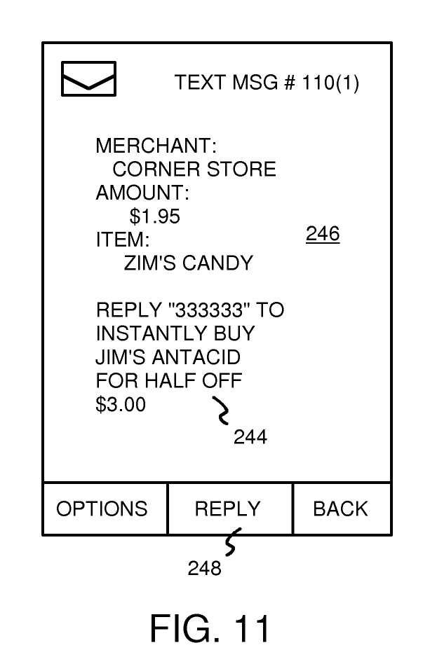

FIG. 11 highlights a SMS text messages that advertises an instant buy using the SMS control system. A merchant sends advertisement SMS text message 246 to a customer's mobile phone. The advertised item, price, and the merchant are shown in advertisement SMS text message 246.

The customer could immediately accept the deal and buy the item in advertisement SMS text message 246 by touching reply button 248 and replying with his PIN code. The deal would be redeemed and the cost charged to the customer's primary credit card, or to back-up credit or debit cards, according to the customer's payment instructions that were previously configured.

Secondary advertisement 244 in advertisement SMS text message 246 contains a SMS code that allows the customer to instantly buy a different item. The customer can hit reply button 248 and enter this SMS code to instantly buy the other item.

### Alternate Embodiments

Several other embodiments are contemplated by the inventors. For example, many variations of the SMS text messages are possible, and various combinations of messages and replies are possible. There may be several payment sources for a customer that may be stored in one or more store credit queues that are processed in a pre-defined order, such as using store vouchers, then gift cards specific to that merchant, then more general gift cards, then a debit or credit card.

Text messages to customer mobile phones and other mobile devices that are generated by broker server instances 70 are formatted as SMS messages using SMS gateway API 80. Secure Hyper-Text Transfer Protocol (HTTPS) connections may be used in place of SMS and issued and then received by broker server instances 70. SMS reply messages and instant buy messages from customer mobile devices are returned using SMS gateway API 80 to broker server instances 70, or using HTTPS or other connections or protocols. Thus while SMS has been described, HTTPS or other mobile protocols and applications may be substituted. Multimedia Messaging Service (MMS) or other protocol messages with graphics, audio, or video may be substituted for SMS.

Store vouchers or credits may be purchased at a discount to face value. A third party such as an advertiser, a non-profit group such as a school booster club, consolidator, or other third party may also receive a credit when the store voucher is purchased or otherwise obtained. Non-profits can sponsor campaigns to get consumers to purchase store vouchers, with a portion of the store's proceeds going back to the non-profit. Other variations of giveback initiatives may be substituted.

Deal sharing could operate on store vouchers, credits, gift cards, discounts, sales, or other promotions that function as “deals” that are shared among a group of customers in a grouped account, or customers that link to each other or otherwise offer to share their deals. A customer could also receive a hardcopy deal, such as on a flyer or cash register receipt, or could view a similar deal on a poster at the store, online, on TV, or by other advertising. A code printed on the displayed or hardcopy deal could be sent to the SMS control system, such as by a SMS text message, or by entering the hardcopy deal code on the web site for the SMS control system. The hardcopy deal code could be looked up by the broker server instances and a store credit or deal created for the customer. The created credit or deal could then be shared with other customers, such as by being entered in Customer A's store credit queue and Customer B's store credit queue. A third party service could also collect such deals and share them with customers.

While SMS-verified logon to various third-party web sites has been described, SMS verification may also be used for activating physical devices such as Automated Teller Machines (ATMs). The customer could avoid carrying an ATM card and instead activate a SMS-control API 60 executing on the ATM machine that performs the steps in FIG. 3, where the third-party website is the bank or vendor controlling the ATM machine. The customer could type in his phone number into the ATM or perhaps use NFC and tap his phone.

In some embodiments, the POS terminal will also allow the customer to enter his approval PIN, and the SMS verification skipped. Of course, this has lower security and may not be implemented in other embodiments requiring better security. This is useful for when the customer does not have his phone. The merchant could also ask the customer to select the payment source from among a list provided by SMS control system 20. The customer could also have pre-configured short code names (short codes or trigger codes) for each payment source, such as “biz visa” that the store clerk could enter into the POS terminal. The payment source could also be selected by exchanging another set of SMS messages when the customer is using his mobile device.

While sign 240 has been shown with a short code and instructions to make an instant purchase using SMS, sign 240 could be a cardboard or paper sign, a billboard, a flyer, an electronic sign, a message on a package such as on a soda can, an audio message such as a radio advertisement or a television message, etc. Purchases could be shipped to the customer using a pre-defined shipping address in SMS user database 52. Rather than displaying the deal's price, sign 240 could also have a short code that the customer sends by SMS to receive the deal price or other details in a SMS message, rather than seeing the full deal on sign 240.

Most mobile devices have a unique identifier such as an International Mobile Equipment Identity (IMEI) number, which is a 15-digit serial number, and/or an International Mobile Subscriber Identity (IMSI), which is a 64-bit field store on the Subscriber Identity Module (SIM) card inside the mobile device. Mobile device 10 must use these unique identifiers to make a call over a cellular network. An encryption key may be used that is related to these unique identifiers. When a mobile phone is lost or stolen, these numbers may be placed on a black list to prevent their use. Thus mobile device 10 contains security features that are intended to quickly deactivate stolen phones.

SMS control system 20 may be configured to only send SMS text messages to valid phone numbers. SMS module 26 is an SMS application that sends SMS text messages over the cellular network, and excludes third party software such as text-messaging applications that execute on smartphones and PC's. These third-party applications are excluded since they allow the user to create an email address to receive text messages, and these email addresses are not necessarily the customer's mobile phone number. Thus SMS module 26 uses the customer's mobile phone number to receive SMS messages. Some smartphones may allow text messaging or other messaging by several methods, such as over a WiFi/cellular data network (such as Google Voice). These programs may include SMS module 26 that sends standard SMS text messages over the cellular network as a sub-set of their features. SMS control system 20 only communicates using standard SMS text messaging, or using a secure HTTPS connection that can be validated with the customer's mobile phone number, such as an HTTPS connection that can only operate on mobile device 10, not on PC's or other devices.

SMS control system 20 sends text messages to mobile device 10 when mobile device 10 has not been deactivated or blacklisted by the cellular carrier. SMS control system 20 inherently verifies the customer's mobile phone number since only that unique mobile device 10 can receive those SMS text messages, or receive an HTTPS connection from SMS control system 20. The reply SMS text message with the approval PIN must have been sent from mobile device 10, operating with an IMSI, IMEI, or other device identifiers.

When mobile device 10 is a smartphone configured properly, SMS gateway 56 may instead send the text message using a Secure Hyper-Text Transfer Protocol (HTTPS) connection that sends and receives Transport-Control-Protocol Internet Protocol (TCP/IP) packets with mobile device 10 over a cellular or other data network.

There may be two factors of authentification required, in addition to the customer's phone number. The correct zip code (or POS PIN) must be entered at a POS terminal, and the correct approval PIN must be sent as a SMS text message from mobile device 10.

The primary customer on a grouped account could be notified by SMS text message when another sub-user makes a purchase. The grouped account could be configured so that purchases above a specified dollar amount must be approved by the primary customer while purchases below the specified dollar amount may be approved by a sub-user. Parents could allow some purchasing below a specified limit for children using this feature. The primary customer could approve the sub-user's purchase by replying with the primary customer's approval PIN. SMS control system 20 could require both the primary customer and the sub-user to reply to SMS messages before the purchase is approved.

Many variations of display screens of a POS terminal are possible, and for other displays and web pages and SMS messages shown in the drawings. While SMS control system 20 using SMS text messaging has been described, SMS control system 20 may use HTTPS or Hyper-Text-Markup-Language version 5 (HTML5) or later when connecting to some advanced smartphones or other mobile device 10. SMS control system 20 may have the ability to use SMS for older mobile phones, and more advanced and secure connections that feature handshaking and packet exchange with more advanced mobile devices. Encryption keys may also be exchanged in some of these advanced connection methods. For example, a 256-bit encryption scheme may be used.

While a POS terminal has been described as being operated by a store clerk or employee, some POS terminals may be self-serve and operated by the customer. Other POS terminals may have the customer enter information on a small keypad so that the store clerk does not see this information, such as a POS PIN. POS terminal could also be located at a call center where the customer is not physically present, or be part of an online store, such as part of a checkout shopping program. POS terminals traditionally have a drawer for accepting cash, and are a replacement for a cash register.

A POS terminal could be on a mobile device such as a tablet, mobile phone, or other mobile device. The POS terminal could be a game console, a smart refrigerator or other smart appliance, a gasoline pump, a smart TV, a set-top box, a GPS device, a WiFi router, a tablet, a laptop, a camera, any video-based interface system, an audio system with some interface to purchase, any Internet device with a screen, or any connected device with a remote web interface/software interface. The generic term POS endpoint is intended to include POS terminals, whether traditional stationary cash registers, mobile tablets or other devices that a store clerk carries around a store, mobile applications that execute on customers' smartphones, vendors' shopping websites that customers can browse to, and the vendor network which includes other systems such as at a global headquarters, which may include a phone center that receives orders from customers.

While the customer either verbally telling the sales clerk or manually typing in the customer's mobile phone number and zip code or POS PIN has been described, voice recognition software could be used to capture the information. A random or other security question could be asked of the customer, either in place of the zip code or in addition to the zip code. Some embodiments may rely on only the mobile phone number, not a zip code or second piece of information from the customer. Some advanced smartphones may be detectable by the POS terminal, such as over a wireless network, and this could be an additional factor for verification. The SMS control system could be used in combination with other security and payment systems.

If the zip code or POS PIN does not match, SMS control system 20 could initiate a voice call to mobile device 10 and have an operator or a computerized system ask the customer for additional or backup verification. This additional verification could also be sent by SMS text messaging, email, or other methods. These phone calls could be recorded.

If verification fails, the logon, admittance, or purchase is blocked. The customer could be notified by other means that does not rely on the physical possession of mobile device 10, such as email, a call to a home phone or to a friend's phone, and/or mail. A security group at SMS control system 20 or a bank or credit card company could also be notified, as could the cellular carrier. An SMS message indicating that the purchase has been declined may also be sent, either when the approval PIN is not matched, or bank authorization network 22 fails to authorize the charge, such as for insufficient credit or funds. Various steps may be repeated for a fixed number of times, such sending the SMS message again if the customer mistakenly types in the wrong approval PIN.

While the customer replying to the SMS text message with her approval PIN has been described, the customer could also be asked to answer a multiple-choice security question, enter some other piece of information, or even reply with a random code that is part of the SMS text message. For example the SMS text message could say “reply with code 5251”. The customer then replies with a text message saying “5251”.

SMS control system 20 may have the merchant install a plugin application on a POS terminal or otherwise modify its software. However, the customer does not have to install any software on mobile device 10. The customer only has to link his mobile phone number to his payment method and provide verification information. The customer may do this by logging on to the web site for SMS control system 20, or its parent company, or a business partner's web site that provides this linking. The customer could call in to a call center to register and link his phone number and provide payment and verification information over the phone, or even in person at a store, such as at a POS terminal. The customer could also use a smartphone application that uses HTML5 or HTTPS to register for, configure, and monitor use of SMS payment.

Payment sources could include credit cards, debit cards, gift cards, checking accounts or other bank or brokerage accounts, various merchant programs such as reward points programs or loyalty programs, or any other money or quasi-money source. The user may define nicknames for payment sources and configure rules for selecting payment methods, such as to use a particular card at a particular merchant, default cards, backup cards, etc. The SMS payment configuration web site could provide a list of all merchants accepting SMS payments, allowing the customer to configure various cards or payment sources for various merchants. Some merchants may offer discounts or other incentives, or display advertising to the customer on the SMS payment web site. Various menus or dialog boxes may be used to assist the customer in configuring payment sources and rules.

Registered customers may suspend payments by SMS control system 20. The customer could telephone a call center for SMS control system 20 to request suspension of a particular transaction, or to suspend all transactions, such as if mobile device 10 is lost. The customer could also suspend transactions by logging on to the SMS control system website and selecting a suspend transaction feature. In some embodiments the customer may be able to suspend transactions at a POS terminal by telling the store clerk, who uses the SMS payment plugin application to suspend the customer's SMS pay account. The customer could also send a specific trigger code by SMS to SMS control system 20 that causes the account to be frozen immediately.

While SMS control system 20 creating transaction packets of a request to bank authorization network 22 have been described, SMS control system 20 could notify the merchant of authorization by SMS, send the customer's payment information, and then allow the merchant to directly process the transaction with bank authorization network 22. Several variations of authorization are possible. The merchant may handle authorization with the bank or financial network, and merely use the SMS control system to exchange SMS text messages with the customer for verification, with the customer still providing a copy of his credit card to the merchant. In this variation, the SMS control system is simply an additional verification method. Alternately, the SMS control system could send the customer's payment information to the merchant rather than to the authorization network, or could provide this information to a third party who then combines the customer's payment information with information from the merchant before sending the authorization request to the authorization network. The authorization network itself may be quite complex with several intermediate steps and processes.

A customer could be a retail shopper, and online shopper, a wholesale purchaser, a program or application user, or other purchaser of goods, services, or software. The customer's phone number and zip code or POS PIN could be encrypted for transmission from the POS terminal to SMS control system 20. Other messages could also be encrypted, partitioned, scrambled, or otherwise modified. SMS control system 20 could further verify that the SMS reply message is from the customer's mobile device 10 by matching the user's mobile phone number in the reply SMS message, or by matching text copied in the reply SMS message from the original SMS text message sent to the customer.

A single profile picture of the customer may be stored in SMS user database 52, or additional history of pictures may be stored. These additional pictures may be references with previous pictures for further security steps, such as to prevent a completely different person from using the account, since pictures of the original account owner are retained. Profile pictures may be linked to POS PIN(s) for multi-use cases such as allowing additional authorized users on the account, such as for Family, Corporate, or Group accounts.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A computer-implemented method for verifying admittance using a mobile device comprising:
receiving a mobile device number for the mobile device at a location;
sending the mobile device number and a location identifier of the location to a messaging control system;
using the mobile device number of the mobile device to find a located user record for a customer in a user database, the mobile device number associated with the customer;
sending a mobile message to the mobile device, the mobile message causing an admittance request to be displayed to the customer on the mobile device;
receiving a reply mobile message from the mobile device, the reply mobile message including an approval code from the customer;
matching the approval code from the reply mobile message to a stored approval code in the located user record to indicate approval of the admittance request by the customer;
using the location identifier to locate an admittance record associated with the location for the customer in the user database; and
sending an admittance approval to the location when the approval code is matched and the admittance record is located;
whereby the customer is approved for admittance at the location when the admittance approval is received by the location.

2. The computer-implemented method for verifying admittance of claim 1 further comprising:
sending a confirming mobile message to the mobile device when the approval code is matched and the admittance record is located, the confirming mobile message including an indication of authorization of the admittance request.

3. The computer-implemented method for verifying admittance of claim 1 further comprising:
redeeming the admittance record to reduce a quantity of admittances available.

4. The computer-implemented method for verifying admittance of claim 1 wherein the location is an admittance gate at a physical location of a movie theater, a theater, a concert venue, a club, or a gym.

5. The computer-implemented method for verifying admittance of claim 1 wherein the location is a virtual location on an Internet, the virtual location being a third-party website, wherein the customer is approved for logon to the third-party website by the admittance approval.

6. The computer-implemented method for verifying admittance of claim 5 further comprising:
reading a customer account number from the admittance record associated with the location for the customer in the user database;
sending the customer account number to the location with the admittance approval.

7. The computer-implemented method for verifying admittance of claim 1 further comprising:
receiving a request to purchase an admittance record having a purchase amount;
sending an authorization request to a financial authorization network, the authorization request including the purchase amount and payment information for the customer, wherein the payment information is obtained using a pointer in the located user record;
receiving an authorization code from the financial authorization network, and blocking purchase of the admittance record when the authorization code indicates a denial; and
adding the admittance record to the user database and associated with the customer when the authorization code is received.

8. The computer-implemented method for verifying admittance of claim 7 further comprising:
generating the request to purchase the admittance record by selecting a payment source from a queue of payment sources, the queue of payment sources being associated with the located user record in the user database;
wherein the queue of payment sources include one or more of a credit card, a debit card, or a gift card.

9. The computer-implemented method for verifying admittance of claim 1 further comprising:
when the mobile device is a legacy mobile phone that does not support advanced web browsing, sending the mobile message comprises sending a Short Message Service (SMS) text message as the mobile message and receiving the reply mobile message comprises receiving a SMS text message as the reply mobile message;
when the mobile device is an advanced smartphone that has advanced web browsing enabled, sending the mobile message comprises opening a connection to the mobile device using a Secure Hyper-Text Transfer Protocol (HTTPS) connection or using Hyper-Text-Markup-Language version 5 (HTML5) or later to send the mobile message;
whereby mobile messages are adaptive for legacy mobile phones and for advanced smartphones.

10. The computer-implemented method for verifying admittance of claim 9 wherein sending the mobile message comprises sending the mobile message over a cellular network operated by a cellular phone provider using the mobile device number to identify the mobile device;
whereby mobile messages are sent over the cellular network.

11. A mobile admittance system comprising:
a user database having user records for customers, wherein a user record for a customer comprises a mobile device number that uniquely identifies the customer's mobile device;
an admittance queue, coupled to the user database, for locating admittance information for the customer for a plurality of merchant locations;
a merchant gateway for receiving merchant requests for admittance to merchant locations;
a mobile messaging gateway for sending a mobile message to the customer's mobile device over a mobile network using the mobile device number that uniquely identifies the customer's mobile device, and for receiving a reply mobile message from the customer's mobile device in response to the mobile message; and
a plurality of broker server instances, each broker server instance for processing a transaction by receiving a merchant request from a merchant location in the plurality of merchant locations, extracting an extracted mobile device number from the merchant request, using the mobile device number to locate a matching customer record in the user database, matching the merchant location to a matching admittance record in the admittance queue, activating the mobile messaging gateway to send the mobile message to the extracted mobile device number, verifying the reply mobile message, and activating the merchant gateway to send a verified admittance message to the merchant location in response to the reply mobile message;
whereby transactions are processed by verifying the reply mobile message received from the customer's mobile device in reply to the mobile message.

12. The mobile admittance system of claim 11 wherein the user database further comprises:
a payment queue having a plurality of payment sources for a customer record in the user database;
further comprising:
an authorization gateway for sending an authorization request to a financial authorization network when the reply mobile message is received and verified, the authorization request including an identifier of a merchant and payment information located for the customer using the payment queue, the authorization gateway receiving a completed message from the financial authorization network when payment is authorized.

13. The mobile admittance system of claim 11 wherein the plurality of merchant locations comprises virtual locations of third-party websites;
wherein the admittance information in the admittance queue comprises a third-party user identifier that identifies the customer at a website for the merchant location.

14. The mobile admittance system of claim 11 wherein the plurality of merchant locations comprises physical locations of venues, the venues comprising movie theaters, clubs, and auditoriums.

15. The mobile admittance system of claim 11 wherein the user record in the user database further comprises an approval Personal-Identification-Number (PIN) known by the customer;
wherein the reply mobile message further comprises the approval PIN entered by the customer on the customer's mobile device;
further comprising:
an approval PIN verifier for matching the approval PIN from the reply mobile message with the approval PIN stored in the user record in the user database,
whereby the customer approves the transaction by inserting the approval PIN into the reply mobile message.

16. The mobile admittance system of claim 15 wherein the mobile message comprises a Short Message Service (SMS) text message sent to customer's mobile device using the mobile device number read from the user record in the user database;
wherein the reply mobile message comprises a SMS text message that the customer sends in reply to the mobile message, wherein the reply mobile message comprises the approval PIN entered by the customer on the customer's mobile device.

17. The mobile admittance system of claim 15 wherein the mobile message and the reply mobile message are sent over a secure hyper-text transfer protocol (HTTPS) connection or using a Hyper-Text-Markup-Language version 5 (HTML5) or later connection.

18. A mobile-verified admittance system comprising:
merchant means for receiving a mobile device number for a mobile device;
merchant request means for sending a merchant request to a mobile control system, the merchant request including a merchant identifier and the mobile device number;
record lookup means for using the mobile device number extracted from the merchant request to locate a user record in a user database;
mobile message means for sending a mobile message to the mobile device identified by the mobile device number extracted from the merchant request, the mobile message indicating a merchant associated with the merchant identifier extracted from the merchant request;
mobile verification means for receiving a reply mobile message from the mobile device, the reply mobile message including an approval code from a customer in response to the mobile message, and for denying admittance when an approval code mismatch occurs;
admittance store means, associated with the user record, for storing admittance credits for a plurality of merchants;
admittance match means for using the merchant identifier to locate a matching admittance credit in the admittance store means; and
reporting means for reporting a verified admittance in response to the merchant request when the matching admittance credit is located and the approval code matches,
whereby admittance is verified by mobile messages.

19. The mobile-verified admittance system of claim 18 further comprising:
promotion means for sending a promotion mobile message to the mobile device and for receiving an acceptance reply from the mobile device;
deal generating means for generating a deal in response to the acceptance reply, the deal including a store credit, the store credit for reducing a payment amount,
whereby the deal is generated in response to the acceptance reply from the mobile device.

20. The mobile-verified admittance system of claim 18 further comprising:
legacy means, activated when the mobile device is a legacy mobile phone that does not support advanced web browsing, for sending the mobile message using a Short Message Service (SMS) text message sent over a cellular network operated by a cellular phone provider, and for receiving a SMS text message as the reply mobile message;
advanced means, activated when the mobile device is an advanced mobile device, for sending the mobile message by opening a connection to the mobile device using a Secure Hyper-Text Transfer Protocol (HTTPS) connection or using Hyper-Text-Markup-Language version 5 (HTML5) or later to send the mobile message and to receive the reply mobile message,
whereby mobile messaging is adaptive for legacy mobile phones and for advanced mobile devices.
